(19) United States
(12) Patent Application Publication
(10) Pub. No.: US 2025/0337088 A1
(43) Pub. Date: Oct. 30, 2025

(54) BATTERY SYSTEM, ELECTRIC VEHICLE, CELL CONTACTING UNIT AND METHOD FOR ASSEMBLING THE BATTERY SYSTEM

(71) Applicant: SAMSUNG SDI CO., LTD., Yongin-si (KR)

(72) Inventors: Fritz HARING, Bruck an der Mur (AT); Michael URBANITSCH, Raaba-Grambsch (AT); Karina WROBLEWSKA-SOKOLINSKA, Graz (AT)

(21) Appl. No.: 18/813,862

(22) Filed: Aug. 23, 2024

(30) Foreign Application Priority Data
Apr. 26, 2024 (EP) 24172663.7

(51) Int. Cl. H01M 50/293; H01M 50/249; H01M 50/30; H01M 50/507; H01M 50/514

(52) U.S. Cl. CPC H01M 50/293; H01M 50/249; H01M 50/30; H01M 50/507; H01M 50/514; H01M 2220/20

(57) ABSTRACT

A battery system includes: a battery pack including a plurality of battery cells, each having a pair of electrode terminals and a venting valve at a terminal side thereof, the terminal side of each of the battery cells facing a first side of the battery pack in a Z-direction; a cell contacting unit (CCU) carrier on the terminal side of the battery cells; and a plurality of busbars on the electrode terminals of the battery cells and being in mechanical contact with the CCU carrier. The busbars including an elastic member configured to exert a clamping force onto the CCU carrier.

### CROSS-REFERENCE TO RELATED APPLICATION

The present application claims priority to and the benefit of European Patent Application No. 24172663.7, filed on Apr. 26, 2024, in the European Patent Office, the entire disclosure of which is incorporated herein by reference.

### BACKGROUND

### 1. Field

Aspects of embodiments of the present disclosure relate to a battery system, an electric vehicle including the battery system, a cell contacting unit for a battery pack, and a method for assembling the battery system.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle “BEV”) or may include a combination of an electric motor and, for example, a conventional combustion engine (a so-called Plugin Hybrid Electric Vehicle “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells, in a number and configuration depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C.) the battery cell can transition into thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes gas-pressure to increase inside the battery pack. In the worst case, the high temperatures lead to the process (e.g., the thermal runaway) spreading to neighboring cells and a fire in the battery pack. At this stage, the fire is difficult to extinguish.

A conventional venting concept for a battery is to let the venting gas stream discharged by the battery cell(s) expand into the battery housing and escape through a housing venting valve to the outside (e.g., to the environment of the battery housing). However, the hot venting gas stream discharged by the battery cells(s) may flow into tolerance-related gaps below the cell contacting unit carrier, which covers and contacts the battery cells of a battery pack and stays there. The hot venting gas stream then heats up the components inside the battery housing, such as the other battery cells of the battery packs. For example, particles from the venting gas stream may deposit onto the battery cells, which may lead to thermal propagation and may incite thermal runaway in adjacent battery cells, leading to thermal runaway of additional (e.g., adjacent) battery cells of the battery pack.

### SUMMARY

Embodiments of present disclosure provide a battery system that more securely handles a thermal runaway of one or more of its battery cells.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes a battery pack including a plurality of battery cells, each having a pair of electrode terminals and a venting valve at a terminal side thereof, the terminal side of each of the battery cells facing a first side of the battery pack in a Z-direction; a cell contacting unit (CCU) carrier on the terminal side of the battery cells; and a plurality of busbars on the electrode terminals of the battery cells and being in mechanical contact with the CCU carrier. The busbars including an elastic member configured to exert a clamping force onto the CCU carrier.

According to an embodiment of the present disclosure, the battery system may further include a heat resistant cell protection cover arranged between the CCU carrier and the battery cells.

According to an embodiment of the present disclosure, the elastic members of the busbars may be configured to exert the clamping force on the CCU carrier to press the CCU carrier onto the terminal side of each of the battery cells in the Z-direction via the heat resistant cell protection cover.

According to an embodiment of the present disclosure, the CCU carrier may include a CCU elastic member configured to exert a CCU clamping force onto the heat resistant cell protection cover to press the heat resistant cell protection cover onto the terminal side of each of the battery cells in the Z-direction.

According to an embodiment of the present disclosure, the heat resistant cell protection cover may include mica and/or an aerogel.

According to an embodiment of the present disclosure, the elastic members of the busbars may include a spring protrusion and/or a section preloaded in the Z-direction toward the battery cells when the busbars are on the electrode terminals.

According to an embodiment of the present disclosure, the CCU carrier and/or heat resistant cell protection cover may have a recess and/or a slotted opening arranged between adjacent battery cells.

According to an embodiment of the present disclosure, the venting valve of each of the battery cells may be arranged between the electrode terminals of the respective battery cell, and the CCU carrier and/or heat resistant cell protection cover may be sized to be arranged in an area of the terminal sides of the battery cells between the electrode terminals of the battery cells.

According to an embodiment of the present disclosure, the elastic members may be configured to exert a clamping force onto the CCU carrier sufficient to fix the CCU carrier to the battery cells.

According to an embodiment of the present disclosure, the battery system may further include a heat resistant touch protection housing mechanically coupled to the CCU carrier and covering the busbars.

According to an embodiment of the present disclosure, the heat resistant touch protection housing may partially cover a side surface of the battery cells in the Z-direction to provide heat resistance between adjacent ones of the battery cells.

According to an embodiment of the present disclosure, the CCU carrier may include a supporting section for supporting an end of the heat resistant touch protection housing extending between the CCU carrier and the heat resistant touch protection housing in the Z-direction.

According to another embodiment of the present disclosure, an electric vehicle includes the battery system as described above.

Yet another embodiment of the present disclosure provides a cell contacting unit (CCU) for a battery pack. The battery pack includes a plurality of battery cells, each having a pair of electrode terminals and a venting valve at a terminal side thereof. The terminal side of each of the battery cells faces a first side of the battery pack in a Z-direction. The CCU includes a CCU carrier and a plurality of busbars on the CCU carrier. The busbars include an elastic member configured to exert a clamping force onto the CCU carrier to press the CCU carrier onto the terminal side of each of the battery cells of the battery pack in the Z-direction when the CCU carrier is on the battery pack.

Yet another embodiment of the present disclosure provides a method for assembling a battery system. The method includes providing a battery pack including a plurality of battery cells, each having a pair of electrode terminals and a venting valve at a terminal side thereof, the terminal side of each of the battery cells facing a first side of the battery pack in a Z-direction, providing a CCU as described above, and arranging the CCU carrier of the CCU on the terminal side of each of the battery cells of the battery pack, and arranging the busbars of the CCU on the electrode terminals of the battery cells.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic cross-sectional view of a battery system according to an embodiment of the present disclosure.

FIG. 2 is a top view of the battery system shown in FIG. 1.

FIG. 3 is a schematic cross-sectional view of the battery system shown in FIG. 1 taken along a stacking direction.

FIG. 4 is a schematic flow chart describing steps of a method for assembling the battery system shown in FIG. 1 according to an embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization, such as surface metallizations and/or pins, and/or may include conductive polymers or ceramics. Further electrical energy might be transmitted via wireless connections, such as by using electromagnetic radiation and/or light.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a battery pack. The battery pack includes a plurality of battery cells. The battery cells of the plurality of battery cells each have a pair of electrode terminals and a venting valve disposed at a terminal side of the battery cells. The terminal side of each of the battery cells faces a first side of the battery pack in a Z-direction. Each venting valve may be configured to allow for a venting gas stream to be discharged from the respective battery cell during a thermal runaway of the corresponding battery cell. For example, the venting valves may open (e.g., may burst) upon a reference pressure (e.g., a predetermined pressure) being exceeded. The venting valves are provided at or in venting exits, such as in a venting opening, in the battery cells. The battery cells may be accommodated inside a battery housing of the battery pack and/or the battery system. The battery cells may be arranged, or stacked, along a stacking direction to form one or more cell stacks. The battery cells may be interconnected via an electrical connector, for example, busbars, contacting respective electrode terminals of the battery cells to form one or more battery modules/battery packs. The battery cells may be arranged to form one or more battery packs. In a battery pack, the battery cells may be electrically interconnected, for example, in series and/or in parallel. Multiple of these battery packs may form a battery module. The battery cells may be, for example, prismatic cells.

The battery system further includes a cell contacting unit (CCU) carrier disposed on the terminal side of each of the battery cells. The CCU carrier may have a rectangular shape. The CCU carrier, however, is not limited to the rectangular shape. The CCU may have any suitable shape for fitting to the battery pack, for example, it may be square-shaped or ellipsoidal-shaped. The CCU carrier may further include measuring lines for transmitting at least one physical property of the battery cells. The physical property may be, for example, voltage, current, or temperature of the battery cells. The CCU carrier may be attached to the terminal side of each of the battery cells, for example, by a fixation element, such as a screw, bolt, or adhesive.

The battery system further includes a plurality of busbars. The busbars of the plurality of busbars are disposed on the electrode terminals of the battery cells. For example, the busbars may be attached to the electrode terminals by, for example, welding. The busbars are further in mechanical contact with the CCU carrier. The mechanical contact exists between the busbars and a surface of the CCU carrier facing away from the first side of the battery pack. For example, at least a section (or portion) of a first half of the busbars is disposed on, for example, welded to, the electrode terminals of the battery cells and at least another section (or portion) of a second half of the busbars opposite to the first half thereof is in mechanical contact with the CCU carrier.

The busbars each include an elastic member configured to exert a clamping force onto the CCU carrier such that the CCU carrier is pressed onto the terminal side of each of the battery cells in the Z-direction. For example, the busbars are mechanically coupled to the CCU carrier by the exerted clamping force. Accordingly, the elastic members are configured to exert a clamping force onto the CCU carrier sufficient to individually close tolerance-related gaps in the Z-direction between the battery cells of the plurality of battery cells and the CCU carrier. Due to the exerted clamping force of the elastic members, a gap, for example, the tolerance-related gaps, between the battery cell top covers and the CCU carrier in the Z-direction can be prevented (e.g., can be closed). In other words, the sealing between the battery cell top covers and the CCU carrier can be improved. The elastic members may be integrally formed with the busbars.

If one of the battery cells is affected by (or experiences) thermal runaway, a hot venting gas stream is discharged from the affected battery cell via its venting exit. Because gaps, for example, the tolerance-related gaps, between the battery cell top covers and the CCU carrier in the Z-direction are prevented, the hot venting gas stream cannot flow or stay below the CCU carrier and the risk of thermal runaway spreading to additional battery cells, such as adjacent battery cells of the battery pack, is reduced.

According to an embodiment, the battery system further includes a heat resistant cell protection cover arranged between the CCU carrier and the battery cells. The heat resistant cell protection covers provides additional heat protection, for example, during a thermal runaway. The hot venting gas stream may heat up the components inside the battery housing, such as the other battery cells. For example, particles from the venting gas stream may deposit onto the battery cells, which may lead to thermal propagation and may incite thermal runaway in adjacent battery cells. To protect the battery cells, the heat resistant cell protection cover may be provided covering the battery cells at their terminal side. For example, the heat resistant cell protection cover may be arranged such that it covers the plurality of battery cells at their terminal sides. For example, the heat resistant cell protection cover may cover the top side of the battery cells. In some embodiments, the heat resistant cell protection cover may cover all of the battery cells of the plurality of battery cells, for example, the heat resistant cell protection cover may extend over the terminal sides of all of the battery cells of the plurality of battery cells. The heat resistant cell protection cover may be attached to the terminal side of each of the battery cells by a fixation element, such as a screw, bolt, or adhesive.

According to another embodiment, the elastic members of the busbars are further configured to exert the clamping force on the CCU carrier so that the CCU carrier is pressed onto the terminal side of each of the battery cells in the Z-direction via the heat resistant cell protection cover. Because the elastic members of the busbars also press the heat resistant cell protection cover onto the terminal side of the battery cells, gaps between the heat resistant cell protection cover and the top cover of the battery cells can also be closed (or prevented) and the sealing of the heat resistant cell protection cover can be improved. Thus, hot venting gas stream cannot flow or stay below the heat resistant cell protection cover such that the risk of thermal runaway spreading to additional battery cells, such as adjacent battery cells of the battery pack, is further reduced.

According to another embodiment, the CCU carrier includes one or a plurality of CCU elastic members configured to exert a CCU clamping force onto the heat resistant cell protection cover so that the heat resistant cell protection cover is pressed onto the terminal side of each of the battery cells in the Z-direction. Due to the CCU elastic members, the heat resistant cell protection cover does not require a separate fixation element and assembly of the battery system may be more easily facilitated. The CCU elastic member(s) may include a spring protrusion and/or a section preloaded in the Z-direction toward the battery cells when the CCU carrier is disposed on the terminal side of each of the battery cells. The CCU elastic members may be integrally formed with the CCU carrier. For example, the spring protrusion and/or the section preloaded in the Z-direction toward the battery cells may be integrally formed with the CCU carrier.

According to another embodiment, the heat resistant cell protection cover includes or consists of mica and/or an aerogel. Mica, which may refer to mica silicate minerals, and aerogel, which is a synthetic porous ultralight material derived from a gel, are heat-resistant materials.

According to another embodiment, the elastic members of the busbars include a spring protrusion and/or a section preloaded in the Z-direction towards the battery cells when the busbars are disposed on the electrode terminals. The spring protrusion and/or the section preloaded in the Z-direction toward the battery cells may be integrally formed with the busbars.

According to another embodiment, the CCU carrier and/or the heat resistant cell protection cover has a recess and/or a slotted hole (e.g., a slotted opening) arranged between adjacent battery cells. Recesses, such as a material weakening portion, or slotted holes, such as elongated slits, between adjacent battery cells facilitate individual movement of the CCU carrier (with respect to the individual battery cells) caused by the individual elastic members of the busbars for each of the battery cells so that differences between the battery cells in the Z-direction can be better compensated, for example, tolerance-related gaps between the battery cell top covers and the CCU or the heat resistant cell protection cover can be better prevented. For example, the recesses and/or slotted holes increase the flexibility of the CCU carrier and/or the heat resistant cell protection cover. The recesses and/or slotted holes extend in a direction orthogonal to the Z-direction and the stacking direction of the plurality of battery cells.

According to another embodiment, the venting valve of each of the battery cells is arranged between the electrode terminals of the respective battery cell. The CCU carrier and/or the heat resistant cell protection cover are sized to be arranged in an area of the terminal sides of the battery cells between the electrode terminals of the battery cells. For example, the CCU carrier and/or the heat resistant cell protection cover fit into the area(s) between the electrode terminals of the battery cells and do not extend over the electrode terminals.

According to another embodiment, the elastic members are configured to exert a clamping force on the CCU carrier sufficient to fix the CCU carrier to the battery cells. For example, the clamping force is higher than a threshold indicating the threshold value between fix and loose of the CCU carrier. Accordingly, no other fixation of the CCU carrier, such as screwing the CCU carrier to the battery pack/system housing, is required. That is, the CCU carrier is only held in place by the clamping force applied from the elastic members of the busbars. In other words, without the elastic members of the busbars, the CCU would be disposed loosely on the battery cells.

According to another embodiment, the battery system further includes a heat resistant touch protection housing mechanically coupled to the CCU carrier. The heat resistant touch protection covers the busbars, for example, at least from touches in the Z-direction. For example, the heat resistant touch protection covers the busbars when viewed in the Z-direction. The heat resistant touch protection may be fixed to the CCU carrier via a clip, that is, it may be clipped to the CCU carrier.

According to another embodiment, the heat resistant touch protection housing further partially covers a side section of the battery cells in the Z-direction to provide heat resistance between adjacent battery cells.

According to another embodiment, the CCU carrier includes a supporting section for supporting an end of the heat resistant touch protection housing extending between the CCU carrier and the heat resistant touch protection housing in the Z-direction.

Embodiments of the present disclosure also provide an electric vehicle including a battery system as described herein, for example, as a traction battery.

Embodiments of the present disclosure also provide a cell contacting unit (CCU) for a battery pack. The battery pack includes a plurality of battery cells, each having a pair of electrode terminals and a venting valve disposed at a terminal side of the battery cells. The terminal side of each of the battery cells faces a first side of the battery pack in a Z-direction. The aspects and features described in view of the above-mentioned battery pack may be analogously applied to the battery pack of the CCU.

The CCU includes a CCU carrier and a plurality of busbars disposed on the CCU carrier. The busbars each include an elastic member configured to exert a clamping force on the CCU carrier such that the CCU carrier is pressed onto the terminal side of each of the plurality of battery cells of the battery pack in the Z-direction when the CCU carrier is disposed on the battery pack. For example, the busbars are held by the CCU carrier such that the CCU carrier including the measuring cables and busbars can be positioned together on the battery pack, for example, the battery cell stack, before the busbars are welded to the cell poles (or electrode terminals). Thus, assembly of the battery system may be facilitated. The busbars have corresponding freedom of movement (e.g., play) in the Z-direction such that they can press the CCU carrier onto each of the battery cells.

Further, embodiments of the present disclosure provide a method for assembling a battery system, namely, the above-described battery system.

According to one step of the method, a battery pack including a plurality of battery cells, each having a pair of electrode terminals and a venting valve disposed at a terminal side of the battery cells is provided. The terminal side of each of the battery cells faces a first side of the battery pack in a Z-direction.

According to another step of the method, a CCU, namely the above-described CCU, is provided.

According to another step, a CCU carrier of the CCU is disposed on the terminal side of each of the battery cells of the battery pack and the busbars are disposed of the CCU on the electrode terminals of the battery cells.

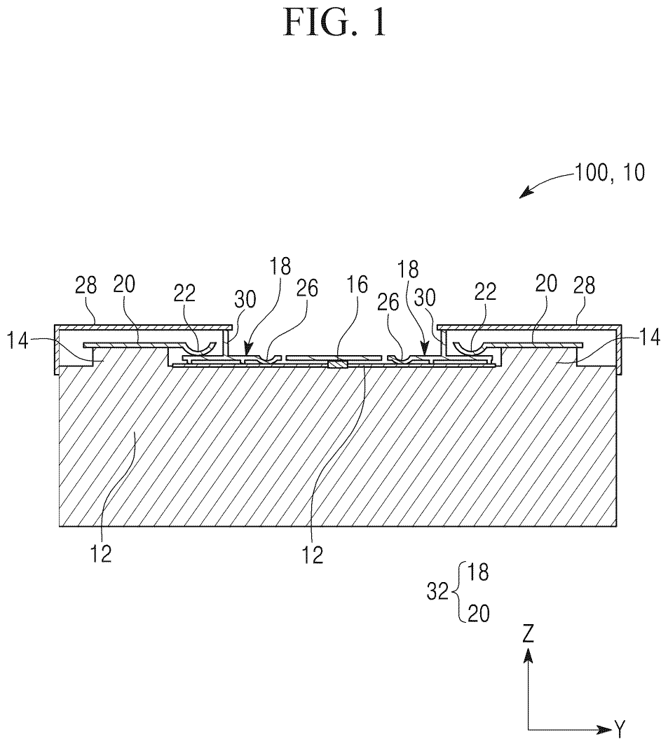

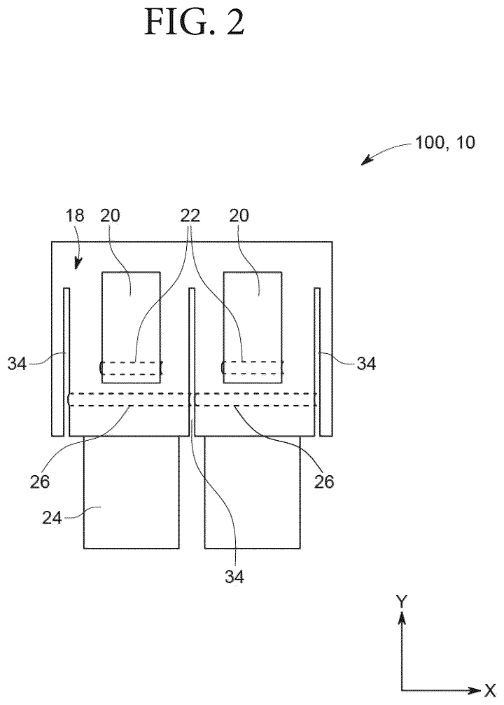

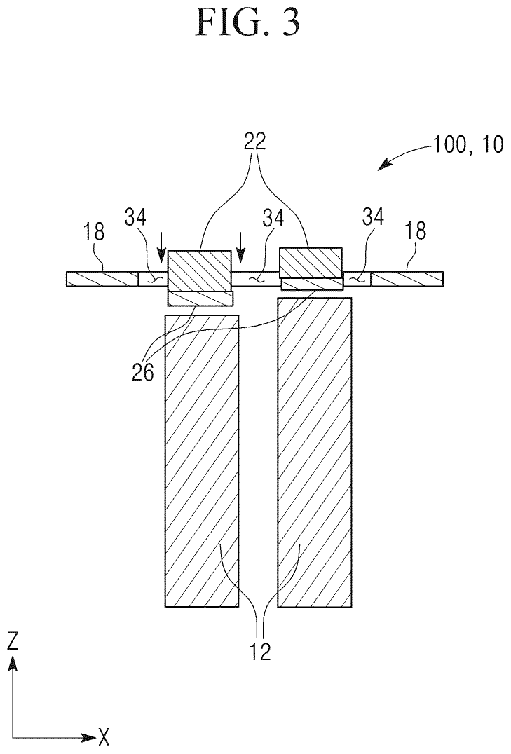

FIG. 1 is a schematic cross-sectional view of a battery system 100, according to an embodiment of the present disclosure, taken along the longitudinal direction of a battery cell 12. FIGS. 2 and 3 respectively illustrate a top view and a schematic cross-sectional taken along a stacking direction of the battery system 100 shown in FIG. 1.

The battery system 100 includes a battery pack 10 including a plurality of battery cells 12. For brevity reasons, FIGS. 2 and 3 depict an example of the battery pack 10 with two battery cells 12. However, this is merely an example, and the battery pack 10 may include more than two battery cells 12. For example, the battery pack 10 may include 3, 4, 5, 6 or any suitable number of battery cells 12. The battery cells 12 are prismatic cells stacked along a stacking direction X to form a battery cell stack (see, e.g., FIGS. 2 and 3).

Each of the battery cells 12 includes a pair of electrode terminals 14 and a venting valve 16 disposed therebetween at a terminal side of the battery cells 12. The terminal side of each of the battery cells 12 faces a first side of the battery pack 10 along a Z-direction. In FIGS. 1 and 3, the Z-direction corresponds to the vertical direction of the image plane, that is, from up to down or vice versa. In other words, the Z-direction may refer to a height direction of the battery cells 12.

The battery system 100 further includes a cell contacting unit (CCU) carrier 18 disposed on the terminal side of each of the battery cells 12 and a plurality of busbars 20. Some of the busbars 20 are disposed on the electrode terminals 14 of the battery cells 12. According to the illustrated embodiment, the busbars 20 are each attached to the corresponding electrode terminals 14 of the battery cells 12, for example, by welding. For example, a first section (or first portion) of the busbars 20 is welded to the electrode terminals 14 of the battery cells 12. The first section of the busbars 20 may be more than half of a length of the busbar 20. As shown in FIG. 1, the busbars 20 are further in mechanical contact with the CCU carrier 18. The mechanical contact between the busbars 20 and a surface of the CCU carrier 18 faces away from the first side of the battery pack 10. A second section (or section portion) of the busbars 20 is in mechanical contact with the CCU carrier 18. The second section of the busbars 20 is opposite to the first section thereof.

The busbars 20 each include an elastic member 22 configured to exert a clamping force (e.g., a clamping pressure) on the CCU carrier 18 such that the CCU carrier 18 is pressed onto the terminal side of each of the battery cells 12 along the Z-direction. The busbars 20, in particular, the second section thereof, are mechanically coupled to the CCU carrier 18 by the exerted clamping force. The elastic members 22 are configured to exert a clamping force on the CCU carrier 18 sufficient to individually close tolerance-related gaps with in the Z-direction between the battery cells 12 and the CCU carrier 18. As shown in FIG. 3, for example, the left battery cell 12 has a smaller height in the Z-direction than the right battery cell 12, which is higher (or taller) in the Z-direction, which would usually cause a tolerance-related gap to exist between the top of the left battery cell 12 and the CCU carrier 18. However, due to the exerted clamping force of the elastic members 22, the existence of such a gap can be prevented. For example, the contact (e.g., the sealing) between the battery cells 12 and the CCU carrier 18 can be improved and spread of thermal runaway to additional battery cells 12, for example, to the adjacent battery cell 12 on the right side in FIG. 3, is mitigated. Due to the tolerance-related gap in the left battery cells 12, the elastic member 22 of the left battery cell 12 is less contracted than the elastic member 22 of the right battery cell 12. That is, the battery system 100 includes tolerance compensation along the Z-direction.

The elastic members 22 of the busbars 20 include a spring protrusion. For example, the elastic members 22 are shaped as a (e.g., round) groove extending along a X-direction (see, e.g., FIGS. 1 and 2). The X-direction may refer to the stacking direction X. Additionally or alternatively, the elastic members 22 may be formed as a section of the busbars 20 that is preloaded (e.g., is bent or plastically deformed) towards the battery cells 12 with in the Z-direction when the busbars 20 are disposed on the electrode terminals 14.

As shown in FIG. 1, the battery system 100 further includes a heat resistant cell protection cover 24 arranged between the CCU carrier 18 and the battery cells 12. The heat resistant cell protection cover 24 is arranged to cover the battery cells 12 at their terminal sides (see, e.g., FIG. 2). For example, the heat resistant cell protection cover 24 covers the top side of the battery cells 12. The heat resistant cell protection cover 24 may extend over the terminal sides of the battery cells 12. Because the heat resistant cell protection cover 24 is arranged between the CCU carrier 18 and the battery cells 12, the exerted clamping force from the elastic members 22 of the busbars 20 onto the CCU carrier 18 is also exerted onto the heat resistant cell protection cover 24. Thus, the existence of gaps between the CCU carrier 18 and heat resistant cell protection cover 24 can be also be mitigated or prevented.

To further reduce the existence of gaps between the CCU carrier 18 and the heat resistant cell protection cover 24, the CCU carrier 18 includes CCU elastic members 26. The CCU elastic members 26 are similar as the elastic members 22 of the busbars 20. The CCU elastic members 26 are configured to exert a CCU clamping force onto the heat resistant cell protection cover 24 so that the heat resistant cell protection cover 24 is pressed onto the terminal side of the battery cells 12 in the Z-direction. The CCU elastic members 26 may include a spring protrusion, for example, a (e.g., round) groove extending in parallel to the grooves in the elastic members 22, for example, along the stacking direction X. Additionally or alternatively, the CCU elastic members 26 may be formed as a section preloaded towards the battery cells 12 in the Z-direction when the CCU carrier 18 is disposed on the battery cells 12.

For example, the CCU carrier 18 and the heat resistant cell protection cover 24 may be loosely disposed onto the battery cells 12 to be fixed (e.g., to be only fixed) by the clamping force exerted from the elastic members 22 and the CCU elastic members 26. For example, the CCU carrier 18 and the heat resistant cell protection cover 24 may be clamped between the busbars 20 welded to the electrode terminals 14 and the top covers of the battery cells 12. Thus, the CCU carrier 18 and the heat resistant cell protection cover 24 do not require separate fixation elements.

As shown in FIG. 2, the CCU carrier 18 and the heat resistant cell protection cover 24 have slotted holes 34 (e.g., elongated slits) arranged between the adjacent battery cells 12, for example, above the gaps between the battery cells 12 in the stacking direction Z. In the illustrated embodiment, three slotted holes 34 are illustrated. The slotted holes 34 extend in a direction orthogonal to the Z-direction and the stacking direction X. For example, the slotted holes 34 extend in a Y-direction, which is orthogonal to the stacking direction X and the Z-direction. The slotted holes 34 increase the flexibility of the CCU carrier 18 and the heat resistant cell protection cover 24 such that bending of the CCU carrier 18 is improved on an individual battery cell 12 basis. Accordingly, the existence of tolerance-related gaps between the battery cells 12 and the CCU carrier 18 and the heat resistant cell protection cover 24 may more efficiently prevented.

The battery system 100 further includes a heat resistant touch protection housing 28 mechanically coupled to the CCU carrier 18. The heat resistant touch protection housing 28 covers the busbars 20 in the Z-direction. The heat resistant touch protection housing 28 also partially covers a side section of the battery cells 12 in the Z-direction to provide heat resistance between adjacent battery cells 12. The heat resistant touch protection housing 28 has an L-shaped cross-sectional shape as shown in, for example, FIG. 1. However, the battery system 100 is not limited thereto, and in some embodiments, the heat resistant touch protection housing 28 may be omitted.

The CCU carrier 18 includes a supporting section 30 for supporting an end of the heat resistant touch protection housing 28 extending between the CCU carrier 18 and the heat resistant touch protection housing 28 in the Z-direction. However, the battery system 100 is not limited thereto, and in some embodiments, the supporting section 30 may be omitted.

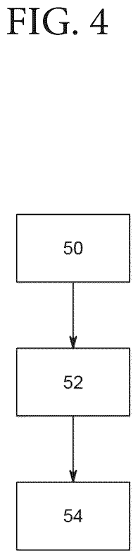

FIG. 4 is a schematic flow chart describing a method for assembling the battery system 100 shown in FIG. 1 according to an embodiment.

According to a first step 50, the above-described battery pack 10 is provided. For example, a battery pack 10 including a plurality of battery cells 12, each having a pair of electrode terminals 14 and a venting valve 16 at a terminal side of the battery cells 12 facing a first side of the battery pack 10 in a Z-direction.

According to a second step 52 of the method, a CCU 32 is provided. The CCU 32 includes a CCU carrier 18, such as the above-described CCU carrier 18, and a plurality of busbars 20, such as the above-described busbars 20, disposed on the CCU carrier 18. The busbars 20 each includes an elastic member 22 configured to exert a clamping force onto the CCU carrier 18 such that the CCU carrier 18 is pressed onto the terminal side of each of the plurality of battery cells 12 of the battery pack 10 in the Z-direction when the CCU carrier 18 is disposed on the battery pack 10.

According to a third step 54 of the method, the CCU carrier 18 of the CCU 32 is disposed on the terminal side of each of the battery cells 12 of the battery pack 10, and the busbars 20 of the CCU 32 are disposed on the electrode terminals 14 of the battery cells 12.

### SOME REFERENCE SYMBOLS

10 battery pack
12 battery cells
14 electrode terminals
16 venting valve
18 cell contacting unit carrier
20 busbars
22 elastic member
24 heat resistant cell protection cover
26 CCU elastic member
28 heat resistant touch protection
30 supporting section
32 cell contacting unit
34 slotted holes
50 first method step
52 second method step
54 third method step
100 battery system

What is claimed is:

1. A battery system comprising:
a battery pack comprising a plurality of battery cells, each having a pair of electrode terminals and a venting valve at a terminal side thereof, the terminal side of each of the battery cells facing a first side of the battery pack in a Z-direction;
a cell contacting unit (CCU) carrier on the terminal side of the battery cells; and
a plurality of busbars on the electrode terminals of the battery cells and being in mechanical contact with the CCU carrier, the busbars comprising an elastic member configured to exert a clamping force onto the CCU carrier.

2. The battery system as claimed in claim 1, further comprising a heat resistant cell protection cover arranged between the CCU carrier and the battery cells.

3. The battery system as claimed in claim 2, wherein the elastic members of the busbars are configured to exert the clamping force on the CCU carrier to press the CCU carrier onto the terminal side of each of the battery cells in the Z-direction via the heat resistant cell protection cover.

4. The battery system as claimed in claim 2, wherein the CCU carrier comprises a CCU elastic member configured to exert a CCU clamping force onto the heat resistant cell protection cover to press the heat resistant cell protection cover onto the terminal side of each of the battery cells in the Z-direction.

5. The battery system as claimed in claim 2, wherein the heat resistant cell protection cover comprises mica and/or an aerogel.

6. The battery system as claimed in claim 2, wherein the CCU carrier and/or the heat resistant cell protection cover comprise a recess and/or a slotted opening arranged between adjacent battery cells.

7. The battery system as claimed in claim 2, wherein the venting valve of each of the battery cells arranged between the electrode terminals of the respective battery cell and the CCU carrier, and/or the heat resistant cell protection cover are sized to be arranged in an area on the terminal sides of the battery cells between the electrode terminals of the battery cells.

8. The battery system as claimed in claim 1, wherein the elastic members of the busbars comprise a spring protrusion and/or a section preloaded in the Z-direction towards the battery cells when the busbars are on the electrode terminals.

9. The battery system as claimed in claim 1, wherein the elastic members are configured to exert a clamping force on the CCU carrier sufficient to fix the CCU carrier to the battery cells.

10. The battery system as claimed in claim 1, further comprising a heat resistant touch protection housing mechanically coupled to the CCU carrier and covering the busbars.

11. The battery system as claimed in claim 10, wherein the heat resistant touch protection housing further partially covers a side surface of the battery cells in the Z-direction to provide heat resistance between adjacent ones of the battery cells.

12. The battery system as claimed in claim 10, wherein the CCU carrier comprises a supporting section for supporting an end of the heat resistant touch protection housing extending between the CCU carrier and the heat resistant touch protection housing in the Z-direction.

13. An electric vehicle comprising the battery system as claimed in claim 1.

14. A cell contacting unit (CCU) for a battery pack, the battery pack comprising a plurality of battery cells, each having a pair of electrode terminals and a venting valve at a terminal side thereof, the terminal side of each of the battery cells facing a first side of the battery pack in a Z-direction, the CCU comprising:
a CCU carrier on the terminal side of the battery cells; and
a plurality of busbars on the CCU carrier, the busbars comprising an elastic member configured to exert a clamping force onto the CCU carrier.

15. A method for assembling a battery system, the method comprising:
providing a battery pack comprising a plurality of battery cells, each having a pair of electrode terminals and a venting valve at a terminal side thereof, the terminal side of each of the battery cells facing a first side of the battery pack in a Z-direction;
providing the CCU as claimed in claim 14; and
arranging the CCU carrier of the CCU on the terminal side of each of the battery cells of the battery pack and arranging the busbars of the CCU on the electrode terminals of the battery cells.
